(19) United States
(12) Patent Application Publication
(10) Pub. No.: US 2016/0249083 A1
(43) Pub. Date: Aug. 25, 2016

(54) TABULATION SYSTEM

(71) Applicant: Panasonic Intellectual Property Management Co., Ltd., Osaka (JP)

(72) Inventors: Yoshiyuki OKIMOTO, Nara (JP); Mitsuhiro KAGEYAMA, Kanagawa (JP)

(21) Appl. No.: 15/065,016

(22) Filed: Mar. 9, 2016

Related U.S. Application Data
(63) Continuation of application No. PCT/JP2015/003875, filed on Jul. 31, 2015.

(30) Foreign Application Priority Data
Feb. 25, 2015 (JP) 2015-035044

(51) Int. Cl. H04N 21/25; H04N 21/442; H04N 21/258; H04N 21/45; H04N 21/2543; H04N 21/466

(52) U.S. Cl. CPC H04N 21/252; H04N 21/2543; H04N 21/4667; H04N 21/25883; H04N 21/4532; H04N 21/44204

(57) ABSTRACT

A first tabulation device includes a classification ID acquisition unit that acquires classification IDs of consumers, a purchase ID acquisition unit that acquires purchase IDs of products or services, and an analysis unit that tabulates the classification IDs and the purchase IDs, and analyzes first tabulation information indicating distribution of the classification IDs with respect to the purchase IDs. A second tabulation device includes a classification ID generation unit that generates the classification IDs, based on frequency of a predetermined behavior of the consumers, and a calculation unit that calculates second tabulation information indicating distribution of the frequency of the predetermined behavior with respect to a purchase ID, based on the first tabulation information input from the first tabulation device and the classification IDs. The first tabulation device acquires the second tabulation information, allowing tabulation of purchase data with which a correlation between them can be analyzed while maintaining confidentiality.

### BACKGROUND

1. Technical Field

The present disclosure relates to tabulation systems for analyzing a correlation between consumers' behavior of consuming content or behavior of moving to particular places, and behavior of purchasing products or the like in a real store.

2. Description of the Related Art

At present, many companies hold product/service purchase records, and can analyze in detail what types of consumers purchase them. On the other hand, for advertisements placed in the mass media such as TV programs and publications, a marketing method of classifying consumers into groups having similar consumption behaviors, and setting a target based on the characteristics of the classified groups has been used. However, this marketing method does not have any sufficient evidence that a classified group performs viewing a TV program or purchasing a publication in which they plan to place an advertisement, and groups having similar consumption behaviors are classified indirectly from questionnaires or the like. Therefore, if consumers' tendency in program viewing and publication purchase and tendency in consumption of products/services of a company that plans to place an advertisement can be analyzed in combination, an advertisement based on actual consumption behaviors will be realized in a TV program or a publication, and improved advertising effectiveness will be expected.

However, such analysis needs associations between identification codes (IDs) of consumers of program viewing and publication purchase and IDs of purchasers purchasing products/services. In this case, a person performing analysis knows what program viewing or publication purchase consumers perform, and what products/services they purchase. Thus, this analysis may be regarded as an invasion of privacy by consumers, developing into a social problem. Therefore, under the current circumstances, companies cannot perform analysis without consumers' acknowledgement.

To deal with this, for example, Unexamined Japanese Patent Publication No. 2002-135221 discloses an information transmission and reception system and a method that allow data viewing analysis with personal information concealed. A broadcast apparatus classifies viewers of broadcast receivers into groups of viewers having very similar attributes and viewing histories, based on previously entered information about personal information such as age, sex, and area of residence, and viewing histories. The broadcast receivers set unique IDs assigned to the classified groups individually as IDs of the viewers, and transmit information on which broadcast stations the ID holders have selected to the broadcast apparatus. This allows the information transmission and reception system to perform data viewing analysis without definitely knowing who the ID holders are through the IDs.

However, when the analysis in Unexamined Japanese Patent Publication No. 2002-135221 is performed on a purchase behavior in a real store, the following problems occur. First, a consumer is assigned an ID with personal information concealed, based on program viewing or publication purchase. The consumer comes to a real store, holding the ID, and purchases a product/service of a company. Thus, a person analyzing a correlation between a tendency in program viewing or publication purchase and the purchase of the product/service cannot know who the consumer who came to the store is, but can know the consumer's taste in program viewing, publication purchase, or the like. By a consumer coming to a real store, his or her taste in program viewing or publication purchase is known to the real store. Although a consumer's personal information is concealed by an ID, a real store often holds personal information through the store's original membership card or the like. This results in an association between the consumer's personal information and taste information, and the consumer's privacy can be invaded.

### SUMMARY

The present disclosure has been made in view of these circumstances, and provides a tabulation system that allows an analyst of a consumption tendency in program viewing or publication purchase, and a purchase tendency analyst who sells products/services, to analyze their correlation without knowing consumers' personal information and taste information on the other side.

A tabulation system in the present disclosure is a tabulation system including a first tabulation device and a second tabulation device, and the first tabulation device includes a classification ID acquisition unit that acquires classification IDs of consumers, a purchase ID acquisition unit that acquires purchase IDs of products or services, and an analysis unit that tabulates the classification IDs and the purchase IDs, and analyzes first tabulation information indicating distribution of the classification IDs with respect to the purchase IDs, and the second tabulation device includes a classification ID generation unit that generates the classification IDs, based on frequency of a predetermined behavior of the consumers, and a calculation unit that calculates second tabulation information indicating distribution of the frequency of the predetermined behavior with respect to a purchase ID, based on the first tabulation information input from the first tabulation device and the classification IDs, and the first tabulation device acquires the second tabulation information.

The present disclosure can provide a tabulation system that allows analysis of a correlation between a consumption tendency in program viewing or publication purchase and a tendency in purchase of a product/service in a real store without invading consumers' privacy.

### BRIEF DESCRIPTION OF DRAWINGS

FIG. 1 is a configuration diagram of a data tabulation system in a first exemplary embodiment;

FIG. 2 is a diagram showing an example of a consumption history recorded in a consumption history recording unit in the first exemplary embodiment;

FIG. 3 is a diagram showing an example of a consumption history recorded in a consumption history storage unit in the first exemplary embodiment;

FIG. 4 is a diagram showing an example of results of tabulating content consumption frequency on each device in the first exemplary embodiment;

FIG. 5 is a diagram schematically showing classifications of content consumers in the first exemplary embodiment;

FIG. 6 is a diagram schematically showing a method for calculating content consumption frequency of each classification ID in the first exemplary embodiment;

FIG. 7 is a diagram showing a table of classification IDs to be assigned to terminal devices in the first exemplary embodiment;

FIG. 8 is a diagram showing a manner in which content consumption rates on each classification ID are recorded in the first exemplary embodiment;

FIG. 9 is a diagram showing an example of a product/service purchase record in a store in the first exemplary embodiment;

FIG. 10 is a diagram showing an example of the classification IDs and sales of each product in the first exemplary embodiment;

FIG. 11 is a diagram showing an example of the classification IDs and sales rates of each product in the first exemplary embodiment;

FIG. 12 is a diagram for explaining calculation of content consumption rates in the first exemplary embodiment;

FIG. 13 is a diagram for explaining a tabulation processing flow in the first exemplary embodiment;

FIG. 14 is a configuration diagram showing a configuration of an entire system in a second exemplary embodiment;

FIG. 15 is a diagram showing an example of a location history recorded in a location history recording unit in the second exemplary embodiment;

FIG. 16 is a diagram showing an example of a location history recorded in a location history storage unit in the second exemplary embodiment; and

FIG. 17 is a configuration diagram in a case where purchase tabulation is performed when a magnetic card or an IC card is presented in the second exemplary embodiment.

### DETAILED DESCRIPTION

Hereinafter, with reference to the drawings as appropriate, exemplary embodiments will be described in detail. However, unnecessarily detailed description will not be given. For example, detailed description of already well-known matters and redundant description of a substantially identical configuration will not be given. This is to prevent the following description from being unnecessarily redundant to facilitate the understanding of those skilled in the art.

The accompanying drawings and the following description are provided for those skilled in the art to fully understand the present disclosure, and are not intended to limit a subject described in the claims.

### First Exemplary Embodiment

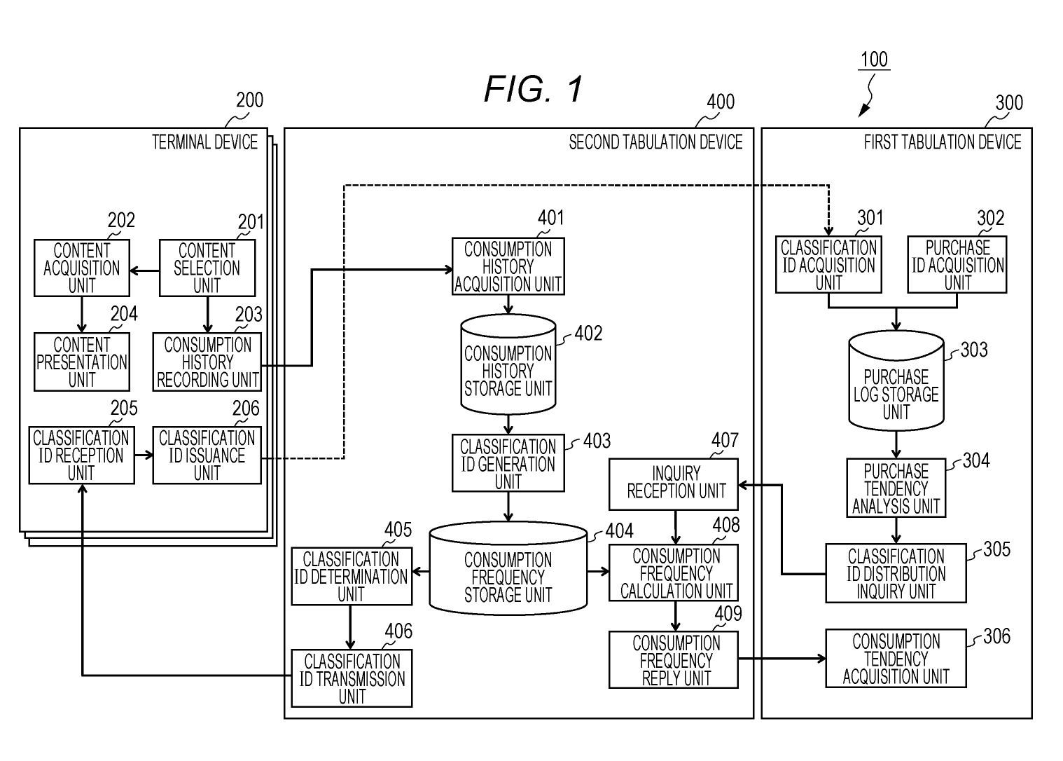

Hereinafter, with reference to FIGS. 1 to 10, a first exemplary embodiment will be described.

### [1-1. Configuration]

FIG. 1 is a diagram showing a configuration of data tabulation system 100 in the first exemplary embodiment. Data tabulation system 100 includes terminal device 200 for a person or a family to view programs with moving picture content or to purchase publications such as electronic books, second tabulation device 400 for performing data tabulation based on consumption histories of program viewing or publication purchase from a plurality of terminal devices 200, and first tabulation device 300 for tabulating purchase histories of products/services purchased by consumers in a real store or the like.

Terminal device 200 is, specifically, a television, a radio, a smartphone, a tablet, an electronic book reader, or the like. In the description below, content program viewing and publication purchase are all expressed as “consuming content.”

Terminal device 200 includes content selection unit 201, content acquisition unit 202, consumption history recording unit 203, content presentation unit 204, classification ID reception unit 205, and classification ID issuance unit 206.

Content selection unit 201 is for selecting content to be consumed, and includes a display to display a content list, and switches or a touch panel for selecting content.

Content acquisition unit 202 acquires content through broadcast, communication, or a memory recording medium, based on a content selection by content selection unit 201. Content acquisition unit 202 includes a tuner wire-connected or connected to a radio antenna, a card reader, or the like. Content acquisition unit 202 may have a recording device such as a random-access memory (RAM) or a hard disk (HDD) for storing content acquired.

Content presentation unit 204 presents content acquired by content acquisition unit 202. Therefore, content presentation unit 204 includes a display panel to display moving pictures or electronic books, a speaker to reproduce music, headphones, and the like.

Consumption history recording unit 203 records content information selected by content selection unit 201, together with its selection time and the like as a consumption history. Consumption history recording unit 203 includes a recording device such as a RAM or an HDD for recording the consumption history. Consumption history recording unit 203 can communicate with a server or the like, and transmits the consumption history to second tabulation device 400. Therefore, consumption history recording unit 203 has a communication means such as a wired LAN, wireless Wi-Fi, or a telephone line.

Classification ID reception unit 205 receives a classification ID of terminal device 200 that is generated in second tabulation device 400 based on consumption histories on terminal devices 200. Therefore, classification ID reception unit 205 includes a communication means such as a wired LAN, wireless Wi-Fi, or a telephone line.

Classification ID issuance unit 206 issues the classification ID assigned to terminal device 200 on a coupon, a membership card for point addition, or the like. Classification ID issuance unit 206 uses a display to display a coupon or a membership card. When terminal device 200 is used for online shopping, classification ID issuance unit 206 does not need to display the classification ID on a coupon or the like, and may be configured to directly transmit the classification ID to a purchase-source online store. In this case, classification ID issuance unit 206 includes a communication means such as a wired LAN or wireless Wi-Fi.

In FIG. 1, terminal device 200 is a single device in which the above-described six components are built, but is not limited to this. For example, terminal device 200 may be separately built in different devices such as a TV apparatus and a smartphone. In this case, it is assumed that the TV apparatus and the smartphone are used by the same person or family.

By consumers holding classification IDs assigned to terminal devices 200 purchasing products/services in a real store, first tabulation device 300 tabulates a purchase behavior in the real store by product group or by product, based on the classification IDs. Then, by inquiring of second tabulation device 400, first tabulation device 300 can acquire information about a content consumption tendency of the classification IDs of the consumers who purchased products, for each product group or each product.

First tabulation device 300 includes classification ID acquisition unit 301, purchase ID acquisition unit 302, purchase log storage unit 303, purchase tendency analysis unit 304, classification ID distribution inquiry unit 305, and consumption tendency acquisition unit 306.

Classification ID acquisition unit 301 acquires a classification ID from a coupon or a membership card issued by classification ID issuance unit 206 of terminal device 200. Therefore, classification ID acquisition unit 301 includes a bar code reader to read bar-coded classification IDs, a keyboard for classification ID entry, or the like.

Purchase ID acquisition unit 302 acquires purchase IDs of products/services purchased by consumers. Therefore, purchase ID acquisition unit 302 includes a bar code reader to read bar codes attached to products, a keyboard for number entry, or the like.

Purchase log storage unit 303 records classification IDs acquired by classification ID acquisition unit 301 and purchase IDs acquired by purchase ID acquisition unit 302, associating them with each other. Purchase log storage unit 303 includes a recording device such as a RAM or an HDD.

Purchase tendency analysis unit 304 analyzes a ratio of classification IDs of purchasers for each product group or each product associated with a purchase ID. Therefore, purchase tendency analysis unit 304 includes a CPU that reads data from purchase log storage unit 303 to perform operation.

Classification ID distribution inquiry unit 305 performs an inquiry to second tabulation device 400 to obtain a content consumption tendency from a classification ID ratio on each product group or each product analyzed by purchase tendency analysis unit 304. The inquiry is performed to second tabulation device 400 by communication via an Internet connection, for example. Therefore, classification ID distribution inquiry unit 305 has a communication means such as a wired LAN or wireless Wi-Fi. However, an inquiry about a classification ID distribution is not limited to communication via an Internet connection, and all communication means including the mail can be used.

As a reply to an inquiry from classification ID distribution inquiry unit 305, consumption tendency acquisition unit 306 can acquire a classification ID distribution for each product group or each product as a content consumption tendency from second tabulation device 400. This allows an operator of first tabulation device 300 to acquire data on what content purchasers of a product group or a product consume. Consumption tendency acquisition unit 306 also has a communication means such as a wired LAN or wireless Wi-Fi, like classification ID distribution inquiry unit 305. As an example of consumption tendency acquisition unit 306, reception of a reply using an Internet connection is possible. Classification ID distribution inquiry unit 305 and consumption tendency acquisition unit 306 may be included in a single communication means.

Second tabulation device 400 has broadly two functions. A first function is to receive consumption histories transmitted from terminal devices 200 and to perform tabulation, and then, based on the tabulation results, to determine classification IDs to be assigned to terminal devices 200 and to transmit the classification IDs. A second function is to calculate a content consumption tendency based on a classification ID distribution inquiry from first tabulation device 300 and to reply to first tabulation device 300.

Second tabulation device 400 includes consumption history acquisition unit 401, consumption history storage unit 402, classification ID generation unit 403, consumption frequency storage unit 404, classification ID determination unit 405, classification ID transmission unit 406, inquiry reception unit 407, consumption frequency calculation unit 408, and consumption frequency reply unit 409.

Consumption history acquisition unit 401 receives consumption histories from consumption history recording units 203 of terminal devices 200. It is easy to realize communication of consumption histories by server-client system communication. Consumption history acquisition unit 401 includes a communication means through an Internet connection, that is, a wired LAN, wireless Wi-Fi, or the like.

Consumption history storage unit 402 records and stores consumption histories of a plurality of terminal devices 200 acquired by consumption history acquisition unit 401. Therefore, consumption history storage unit 402 includes a recording device such as an HDD.

Classification ID generation unit 403 divides a plurality of terminal devices 200 into some groups with similar content consumption tendencies, based on stored consumption histories on terminal devices 200, and generates classification IDs for identifying the groups. At the same time, classification ID generation unit 403 determines a typical content consumption tendency for each classification ID. For this grouping operation and classification ID generation, classification ID generation unit 403 includes a device for reading data stored in consumption history storage unit 402 and a CPU.

Consumption frequency storage unit 404 stores a table showing classification IDs under which terminal devices 200 fall, and a table indicating content consumption rates of each classification ID. It is desirable that a recording device such as an HDD be used for consumption frequency storage unit 404, and tables be stored as a database.

Classification ID determination unit 405 determines in which classification ID each terminal device 200 fits, referring to the tables in consumption frequency storage unit 404.

Classification ID transmission unit 406 transmits a classification ID determined by classification ID determination unit 405 to appropriate terminal device 200. This is desirably realized by communication through an Internet connection. Classification ID transmission unit 406 includes a wired LAN, wireless Wi-Fi, or the like.

Inquiry reception unit 407 receives an inquiry from classification ID distribution inquiry unit 305 of first tabulation device 300. An inquiry communication means only needs to be a communication means predetermined between first tabulation device 300 and second tabulation device 400. An example is communication through an Internet connection.

Consumption frequency calculation unit 408 calculates content consumption frequency for a classification ID distribution inquiry from first tabulation device 300. At this time, consumption frequency calculation unit 408 refers to the table of content consumption rates of each classification ID stored in consumption frequency storage unit 404.

Based on results of calculation by consumption frequency calculation unit 408, consumption frequency reply unit 409 replies to consumption tendency acquisition unit 306 of first tabulation device 300 with consumption rate information on what content is consumed much by classification IDs of consumers who purchased a product group or a product about which an inquiry has been received. Here, a communication means for reply only needs to be a communication means predetermined between first tabulation device 300 and second tabulation device 400. An example is communication through an Internet connection.

### [1-2. Operation]

Tabulation processing in data tabulation system 100 configured as above will be described. Terminal devices 200 represent all devices capable of consuming content, such as televisions, radios, and smartphones. Content includes various types of content such as moving pictures, music, and electronic books. However, in order to avoid complexity in description, program viewing on terminal device 200 that is a TV receiver will be mainly described below as an example. For information tabulated about purchases in a real store, sales of each product in the retail store is used as an example. This is not limited to them, and may be any such as sales of products/services for which advertising effectiveness by a mass advertisement is expected.

### (Collection of Content Consumption Histories)

A consumer switches channels with content selection unit 201 of terminal device 200 possessed by each person or a family to select a desired program. When a program selection is performed, a tuner, content acquisition unit 202, selects a broadcast station and receives the program through a broadcast wave. The program received is image-displayed on a display, content presentation unit 204, and sound synchronized with images is output to a speaker. Viewing information on the program thus selected by the consumer is transmitted as a consumption history to second tabulation device 400 through consumption history recording unit 203, together with an ID unique to terminal device 200. The transmission of the consumption history can be performed through an Internet connection or a telephone line connected to terminal device 200. The consumption history transmitted is stored in consumption history storage unit 402 of second tabulation device 400.

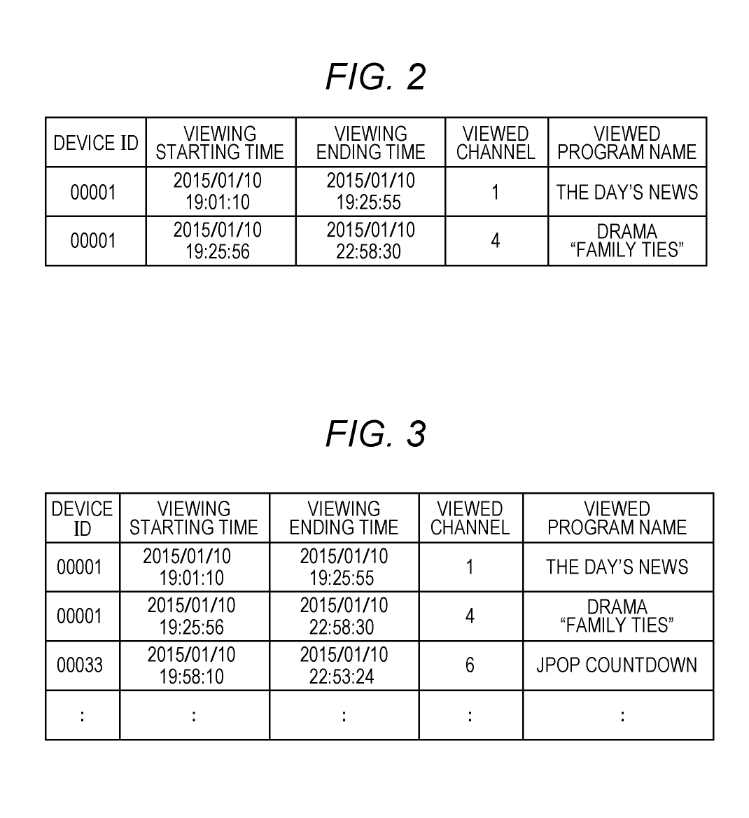

FIG. 2 is a diagram showing an example of the consumption history recorded in consumption history recording unit 203. In this example, “00001” is used as a device ID to identify terminal device 200. It is recorded that on TV receiver “00001,” terminal device 200, “The Day's News” on Channel 1 was viewed from 19:01 on Jan. 10, 2015, and continuously, “Drama ‘Family Ties’” on Channel 4 was viewed after 19:25. This consumption history is transmitted to second tabulation device 400. FIG. 3 is a diagram showing a consumption history stored in consumption history storage unit 402. Consumption history storage unit 402 stores consumption histories with different device IDs in a single table since consumption histories of a plurality of terminal devices 200 are received. Thus, as shown in FIG. 3, the consumption history stored in consumption history storage unit 402 is a table in which consumption histories with different device IDs are mixed. The consumption histories illustrated in FIGS. 2 and 3 also record viewing starting and ending times and viewed channels in addition to device IDs and viewed program names. The consumption histories are not limited to them, and only need to include, as minimal information, information to identify individual terminal devices 200 and information that allows content consumed by terminal devices 200 to be uniquely identified. Other information may be added or deleted as needed to analyze a viewing tendency.

### (Generation of Classification IDs)

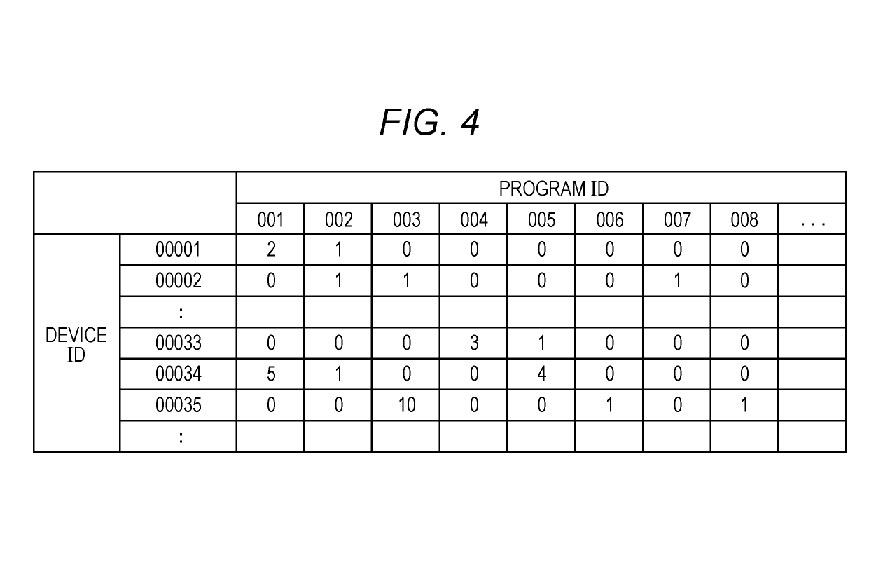

Classification ID generation unit 403 performs classification based on the consumption histories of terminal devices 200 stored in consumption history storage unit 402. The following shows an example of a method for the classification. The consumption histories stored in consumption history storage unit 402 shown in FIG. 3 hold information on programs viewed on terminal devices 200. FIG. 4 shows an example of count of how many times terminal devices 200 viewed what programs, based on the information. FIG. 4 is a diagram showing an example of results of tabulating content consumption frequency of each device. In FIG. 4, device IDs of terminal devices 200 are aligned in rows, and program IDs are aligned in columns. However, programs are previously grouped on the same program basis, and assigned unique program IDs. In each cell in FIG. 4, a viewing count of a program viewed on each terminal device 200 is recorded. For example, on terminal device 200 of device ID=00001, a program of program ID=001 is viewed twice during a survey period.

It only needs to be predetermined what viewing is counted as one time of viewing. For example, various rules such as counting viewing a program for at least half of its broadcast time, viewing a program for at least one minute, and the like as one time of viewing are conceivable. The cell value does not necessarily need to be a viewing count, and may be set at “1” for one or more times of viewing and at “0” for no viewing, for example.

When the device-program table as above is constructed, device groups, that is, groups of consumers using the devices can be formed based on the table. For formation of consumer groups, a technique generally known as clustering is used. Specifically, considering each row in the device-program table shown in FIG. 4 as a vector, each vector can be regarded as a vector representing the characteristics of an associated device or consumer. When vectors representing the characteristics of consumers are thus obtained, a distance between two consumers can be defined, for example, by a cosine distance as follows:

$$D ( a , b ) = \frac{\vec{a} \cdot \vec{b}}{\vert a \vert \vert b \vert} \qquad [ Expression 1 ]$$

wherein a, b mean respective consumers, and vectors representing the characteristics of the consumers determined from the device-program table are indicated by variables with arrows. Absolute value signs in the denominator indicate the magnitudes of the vectors. When a cosine distance is used as a distance between consumers, a possible value is 0 to 1. “1” means that the characteristics of the two consumers agree completely, and “0” means that the characteristics of the two consumers do not agree at all. Although an essential cosine distance can be negative when vector components are negative, in the device-program table, a viewing count is never negative, and thus a minimum value of a cosine distance is zero. As a distance between consumers, a cosine distance has been illustrated, which is not limiting. Other distance definitions such as a geometric Euclidean distance and a Jaccard distance that represents group similarity may be used.

Based on the above distance definition, consumers can be divided into a predetermined number of groups. Various types of clustering therefor have been proposed. It is not limited which one to use. As an example, k-means clustering can be illustrated. K-means clustering divides a set of consumers into k groups, depending on to which one of predetermined k mean vectors a vector of each consumer is nearest. On each of the divided k groups, a mean vector of vectors of consumers constituting the group is determined to update the mean vector that was the basis of the division.

Repeating this processing allows a set of consumers to be divided into k groups in which the sum total of distances from mean vectors of the groups is largest. In this exemplary embodiment, since a cosine distance is used as a distance between consumers, the higher the similarity is, the larger the value is, and thus division by which the sum total of distances is largest is selected. When using a distance definition such as a Euclidean distance in which the higher the similarity is, the smaller the value is, division by which the sum total of distances is smallest is selected in k-means clustering.

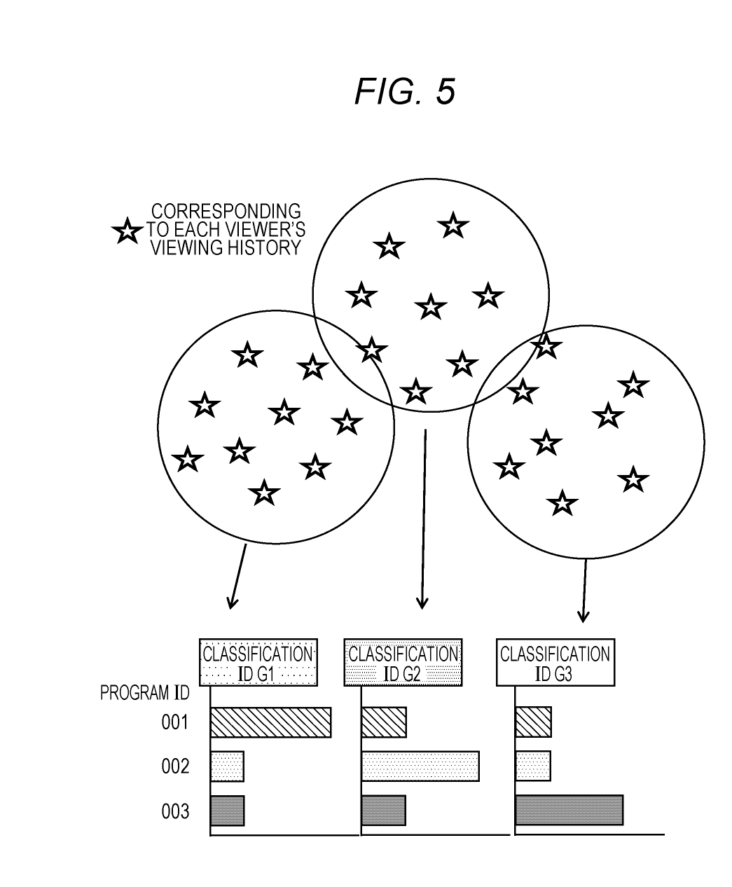

FIG. 5 shows a schematic illustration of a state where consumers are divided into three groups by a clustering method. In FIG. 5, each consumer is schematically represented by a star sign as a point in a vector space with his or her consumption history as a vector. In FIG. 5, consumers in a close positional relationship with each other mean that they are consumers with similar consumption histories, and consumers in a distant positional relationship mean that they are consumers with greatly different consumption histories. FIG. 5 shows a state where consumers in close positional relationships with each other form a group by k-means clustering, with an example where the consumers are divided into three groups.

When groups of consumers with similar tendencies in viewed programs are formed, by tabulating content viewed by consumers belonging to each group, a vector representing viewing rates of programs in each group can be obtained.

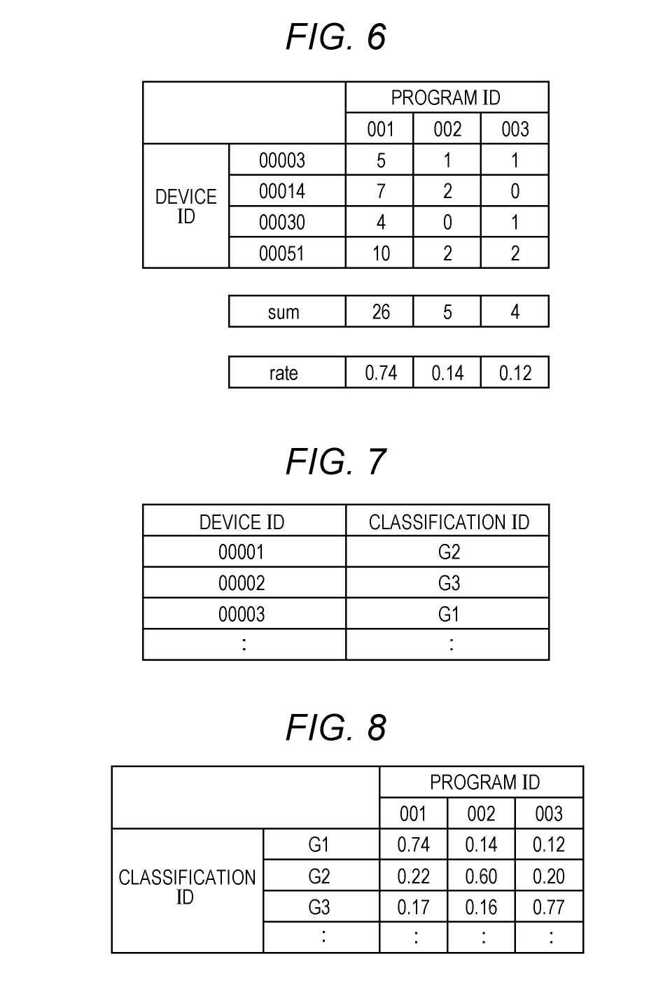

A manner of this calculation is shown in FIG. 6 with a case where the total number of content pieces is three as an example. A device-program table shown in FIG. 6 has a meaning similar to a meaning of the table shown in FIG. 4, but device IDs are limited to device IDs of devices that have been regarded as belonging to the same group by clustering. There are few types of program IDs simply for the purpose of simplifying description. Vertical totalization in the table in FIG. 6 provides a sum total on each piece of content viewed in a group. Further, by dividing the sum total by a total viewing count, an average viewing rate of each piece of content in the group is determined. Differences in content viewing rates in each group thus obtained are schematically shown in a lower portion in FIG. 5.

In the above description, an example of simple grouping by k-means clustering based on numbers of times of content consumption, and calculation of consumption rates of groups based on count of the numbers of times of content consumption in each group has been illustrated. However, in recent years, statistical models called topic models have been devised. Use of these models allows estimation with a higher degree of precision to be performed. For example, use of a method called Latent Dirichlet allocation (LDA), a type of topic model, allows estimation of a probability distribution corresponding to what preference/taste each consumer has, and a probability distribution of programs viewed in relation to a certain preference/taste, from a program consumption history as shown in FIG. 4, in a Bayesian estimation framework. Use of this allows consumers with similar probability distributions on their preferences/tastes to be easily grouped by clustering, and allows a probability distribution of programs to be viewed to be estimated precisely, based on a preference/taste distribution of a group. Thus, for grouping of users and calculation of content consumption rates for each group, use of a method based on a topic model is also effective.

Classification ID generation unit 403 generates classification IDs to identify groups for groups obtained by processing as described above, and calculates in-group content consumption rates for each group. As a result, a table showing into which group each terminal device 200 is classified, and a table showing content viewing rates in each group are stored in consumption frequency storage unit 404. FIGS. 7 and 8 show the two tables schematically illustrated. FIG. 7 illustrates a table of classification IDs to be assigned to terminal devices 200. For example, terminal device 200 of device ID=00001 is assigned G2 as its classification ID. FIG. 8 illustrates a manner in which average content consumption rates on terminal devices 200 associated with classification IDs are recorded. For example, it means that consumption rates of three pieces of program content 001, 002, and 003 on terminal devices 200 to which classification ID=G1 is assigned are 0.74, 0.14, and 0.12, respectively.

### (Transmission and Reception of Classification IDs)

When classification IDs of terminal devices 200 are stored in consumption frequency storage unit 404, a classification ID is extracted for each terminal device 200 by classification ID determination unit 405, and is transmitted to terminal device 200 from classification ID transmission unit 406. Classification ID reception unit 205 of terminal device 200 receives the classification ID transmitted from classification ID transmission unit 406. Terminal device 200 issues a coupon or the like by classification ID issuance unit 206, together with the classification ID and advertisement information or the like received from second tabulation device 400.

A case where a relationship between sales in a retail store and program viewing is analyzed will be taken as an example. The classification ID received by classification ID reception unit 205 is displayed as a coupon by classification ID issuance unit 206 together with the retail store's advertisement information. Alternatively, when classification ID reception unit 205 and classification ID issuance unit 206 are built in a mobile terminal associated with terminal device 200, such as a smartphone used by a consumer, a coupon may be displayed on a screen of the mobile terminal. By a consumer making a purchase, presenting the displayed coupon at the retail store, the retail store can know what product the consumer holding which classification ID bought.

(Product Purchase with Classification ID Presented)

As described above, a retail store or the like associates and tabulates on first tabulation device 300 what consumers having classification IDs assigned to terminal devices 200 bought. For this, classification ID acquisition unit 301 acquires classification IDs assigned to terminal devices 200 from consumers. For example, a classification ID written in a bar code or the like on a coupon presented by a consumer is read. At the same time, a purchase ID of a product/service purchased using the coupon is recorded by purchase ID acquisition unit 302. Specifically, a POS device or the like corresponds to this. A record of the classification ID and the purchase ID associated with each other is stored in purchase log storage unit 303.

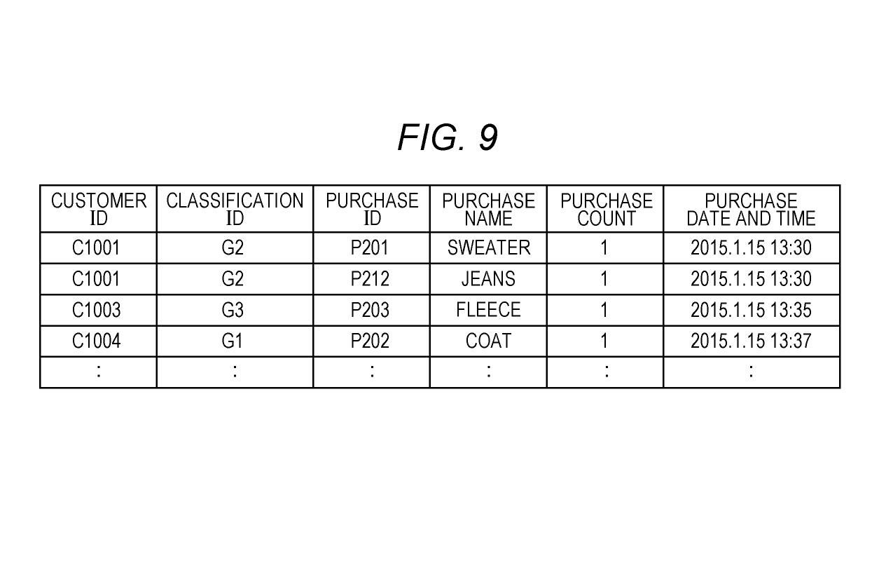

An example of a purchase log stored in purchase log storage unit 303 is shown in FIG. 9. In this example, a purchase log in a clothing retail store is taken as an example. In FIG. 9, customer IDs are IDs managed by the retail store on its own. Classification IDs are IDs presented by consumers on coupons or the like. Purchase IDs are IDs assigned to individual products by the retail store on its own. Purchase names show product names corresponding to purchase IDs. It is important for this exemplary embodiment that classification IDs and purchase IDs are associated with each other and recorded.

In the examples described above, a method for associating classification IDs with purchase IDs of products/services purchased by consumers holding the classification IDs, using coupons including the classification IDs has been illustrated. Tabulation by a retail store receiving presentation of classification IDs and associating the classification IDs with purchase IDs of purchased products/services can be realized in other methods. For example, a method of recording a classification ID issued by terminal device 200 as a piece of membership information when point membership registration is performed at a retail store may be used. In this case, a classification ID output by classification ID issuance unit 206 is added to membership information at the retail store. This allows association between a classification ID and a purchase ID by a consumer presenting a membership card for the purpose of point addition when making a purchase at the retail store. Alternatively, a method of using another system that manages classification IDs of terminal devices 200 and customer IDs of the retail store by associating them with each other, and performs point addition or the like to consumers, to associate a classification ID with a purchase ID at the time of purchase at the retail store can realize the association.

Irrespective of which of these methods is used, information that a retail store or the like performing tabulation on first tabulation device 300 can know on terminal device 200 is only a classification ID, and the meaning of the ID is not disclosed. Thus, at the retail store, a history of content consumption of a consumer on terminal device 200, that is, information about his or her taste in content is not disclosed at all.

### (Analysis of Purchase Tendency)

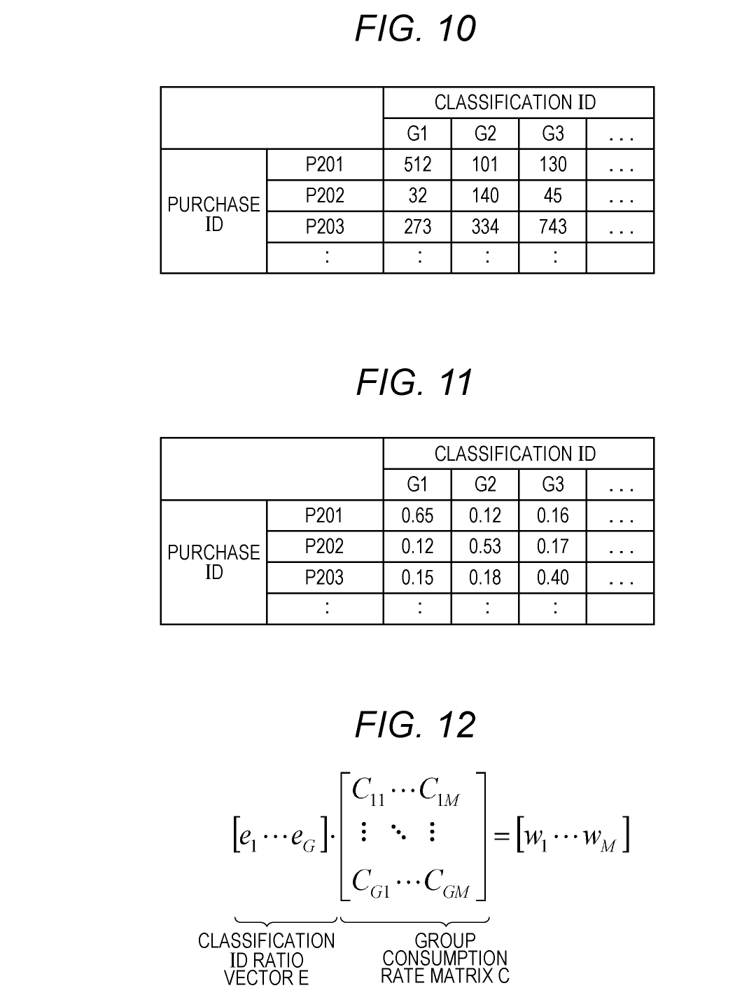

A store that performs tabulation on first tabulation device 300, using the purchase log stored in purchase log storage unit 303, performs analysis of a purchase tendency by purchase tendency analysis unit 304. This analysis is an analysis called a cross analysis, in which a ratio of classification IDs that purchased a product is calculated for each purchase ID or each product group sold in the store. FIGS. 10 and 11 schematically show this. In FIG. 10, sales of each purchase ID are classified by classification ID and calculated. Thus, in this table, the sum total in a row is gross sales of an associated product/service. FIG. 11 is a table in which sales are replaced with a rate of each classification ID when gross sales of each product/service are set at one. Thus, in FIG. 11, the sum total in each row is one.

(Inquiry about Classification ID Distribution)

What the store performing tabulation on first tabulation device 300 wants to know is what content consumers purchasing a product/service prefer, on each product/service or on each group of them. Since classification IDs conceal preference in content, it is necessary to inquire about this. Classification ID distribution inquiry unit 305 performs the inquiry. Information inquired about here is content consumption rates with respect to a component ratio of classification IDs. Specifically, an inquiry is performed using a component ratio of classification IDs on each purchase ID or group of purchase IDs obtained as a result of the above-described purchase tendency analysis. For example, in FIG. 11, on purchase ID-P201, a ratio of classification IDs is G1=0.65, G2=0.12, G3=0.16, . . . , and an inquiry with this ratio is performed. When an inquiry is performed, it is not necessary to disclose what purchase ID this is about. Thus, a store such as a retail store does not let an analysis side having second tabulation device 400 to know sales and sales distribution of a product/service. Further, the inquiry does not inquire about content consumption rates on each classification ID. Therefore, a retail store knows classification IDs of consumers but does not know tastes of consumers themselves in content. At the same time, information on what consumers purchased at the retail store is not known to the side having second tabulation device 400, and thus consumers' privacy is protected.

(Calculation of and Reply with Content Consumption Distribution)

Second tabulation device 400 receiving an inquiry with a classification ID ratio from first tabulation device 300 performs calculation of a content consumption distribution from the classification ID ratio. Specifically, inquiry reception unit 407 receives a classification ID ratio from classification ID distribution inquiry unit 305 via a communication means such as a network. Consumption frequency calculation unit 408 performs calculation of content consumption rates from the classification ID distribution. As shown in FIG. 12, this calculation can be performed by multiplying classification ID ratio vector E with purchase ratio ei of classification IDs inquired about as vector components, having a length of total number G of classification IDs, by group consumption rate matrix C with vectors with content consumption rates of viewing groups as vector components, having a length of number M of content types, as row elements, which are aligned vertically by number G of the classification IDs. The calculation results in a vector having a length of number M of content types, a vector representing consumption rates of M types of content, corresponding to the classification ID ratio given by vector E. Consumption rate vector W is approximately equal to a content consumption ratio on each product obtained when consumers' content consumption frequency is directly disclosed without being concealed by classification IDs to perform a typical cross analysis with product purchase frequency in a retail store, and is information that a store such as a retail store using first tabulation device 300 wants. Thus, in response to the inquiry from classification ID distribution inquiry unit 305, consumption frequency reply unit 409 replies with consumption rate vector W to consumption tendency acquisition unit 306 via the communication means. By obtaining this information, the retail store can know what product's advertisement to be placed in what content to be effective.

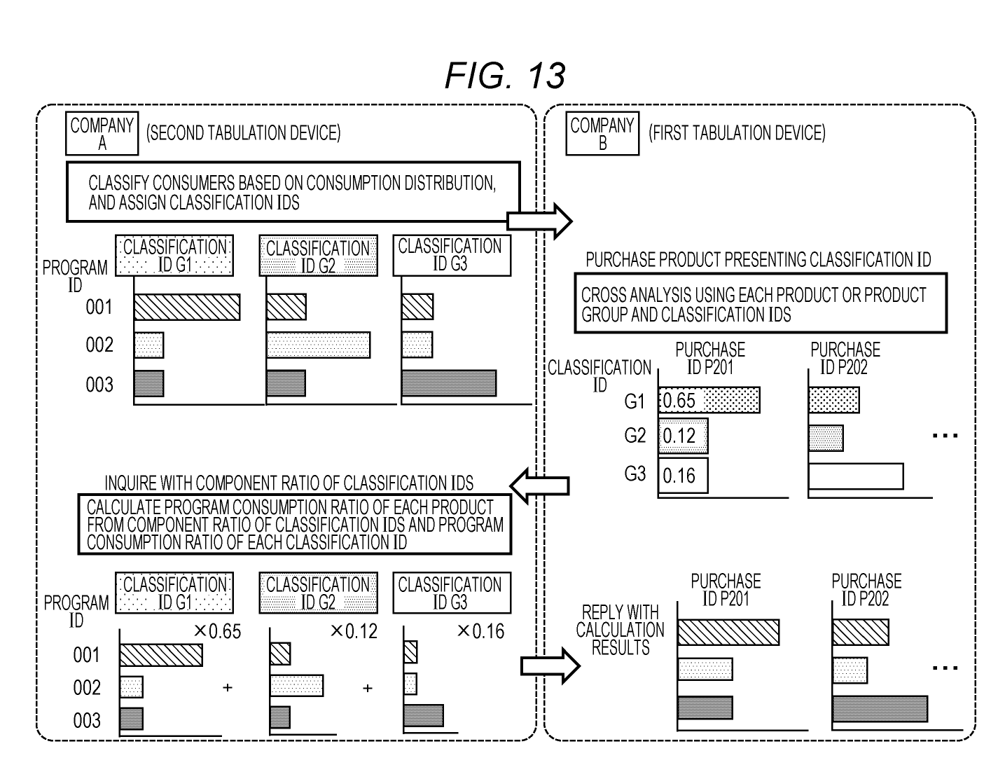

FIG. 13 schematically shows a flow of the above-described tabulation processing. The flow of the tabulation processing will be described according to FIG. 13. Company A having a consumption log of content such as programs operates second tabulation device 400, and Company B such as a retail store performing sales of products/services operates first tabulation device 300. At Company A, second tabulation device 400 assigns classification IDs to consumers, based on results of grouping the consumers with similar content consumption tendencies. When consumers having classification IDs by coupons or the like purchase products at company B, first tabulation device 300 records the classification IDs and the purchased products, associating them with each other, and performs a cross analysis on the products and the classification IDs. As a result, a component ratio of classification IDs is obtained on each product or product group. The component ratio of the classification IDs is inquired about to Company A having second tabulation device 400. Second tabulation device 400 determines an inner product of the component ratio of the classification IDs and the program consumption rates of each classification ID, thereby obtaining content consumption rates on an associated product, and replies with the results to Company B. These inquiry and reply occur for each product or each product group at Company B.

When a number of inquiries on a number of types of classification IDs from first tabulation device 300 to second tabulation device 400 increases, in the end, first tabulation device 300 can estimate program consumption rates of each classification ID. As a result, protection of consumers' privacy, at which this device aims, cannot be maintained. To avoid this situation, the number of inquiries from first tabulation device 300 needs to be limited within a fixed number.

### [1-3. Effects and Others]

As above, the tabulation system according to this exemplary embodiment allows a cross analysis of information on what content consumers consume and information on what products/services they purchased while concealing both of them from each other. Thus, a company can know in which content to place advertisements of its products/services effectively without invading consumers' privacy for their preferences/tastes.

### Second Exemplary Embodiment

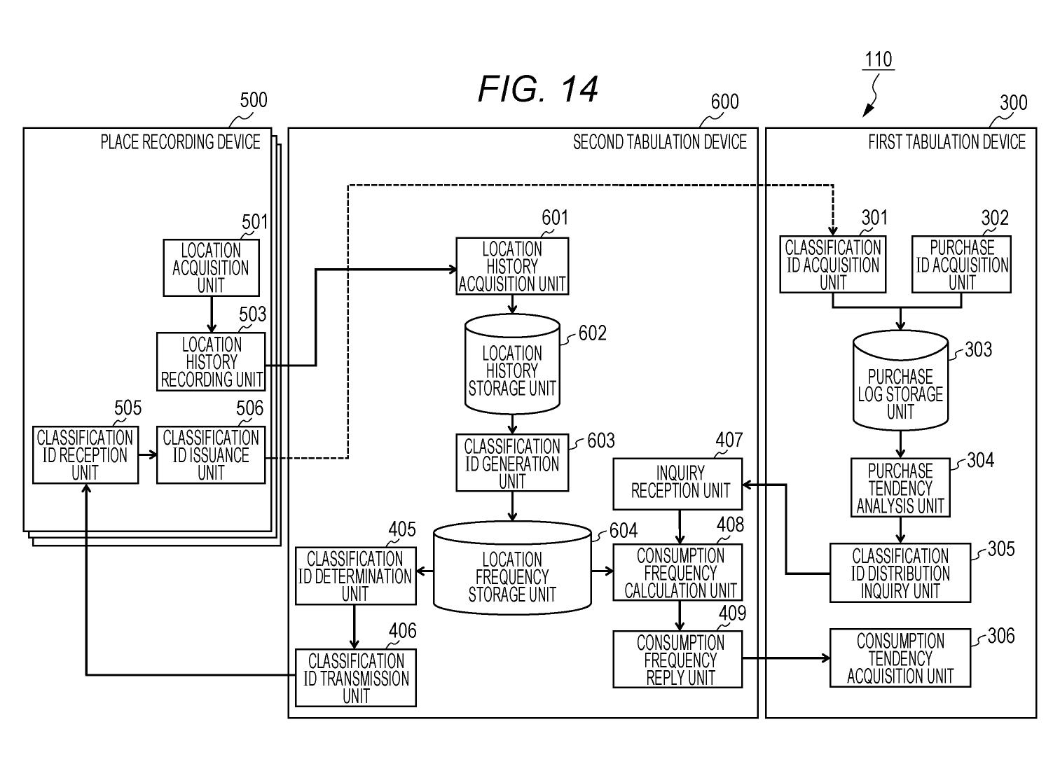

A second exemplary embodiment will be described with reference to FIGS. 14 to 17. The second exemplary embodiment has an object of analyzing relationships between places visited or passed with high frequency and purchases of products/services in a store, based on a location-movement history of consumers. Accordingly, the second exemplary embodiment has a configuration and operation similar to those in the first exemplary embodiment except that a content consumption history used is replaced with a movement history.

### [2-1. Configuration]

FIG. 14 is a diagram showing a configuration of data tabulation system 110 in the second exemplary embodiment. In data tabulation system 110, collection of consumption histories and purchases in FIG. 1 are replaced with collection of consumers' location histories and purchases, and components denoted by the same reference numerals as those in FIG. 1 have the same functions. In particular, first tabulation device 300 has the same configuration and operation as the configuration shown in FIG. 1 and its operation, and will not be described.

Place recording device 500 can take broadly two types of form. One is a mobile terminal such as a smartphone in which place recording device 500 moves with a consumer. The second is an automatic ticket gate at a station or the like in which place recording device 500 is fixed in a particular place and detects consumers who stay there or pass through.

Place recording device 500 includes location acquisition unit 501, location history recording unit 503, classification ID reception unit 505, and classification ID issuance unit 506.

In the first one, a mobile terminal that moves with a consumer, location acquisition unit 501 is a portion to detect a current location of the mobile terminal, and includes an antenna or the like for communication with a GPS or a base station.

Location history recording unit 503 is a portion to record information in which a detected place and an owner of place recording device 500 are associated with each other, and is realized by software using a CPU and memory of the mobile terminal.

Classification ID reception unit 505 is similar to classification ID reception unit 205 in FIG. 1, and receives a classification ID of place recording device 500 that is generated in second tabulation device 600 based on location histories of place recording devices 500. Therefore, for classification ID reception unit 505, a communication means such as a wired LAN or wireless Wi-Fi is used.

Classification ID issuance unit 506 is similar to classification ID issuance unit 206 in FIG. 1, and issues the classification ID assigned to place recording device 500 on a coupon, a membership card for point addition, or the like on a display.

When place recording device 500 in the second one is fixed in a particular place, location acquisition unit 501 is a device to identify a person and detect passing or staying, and includes a device for reading a magnetic card or an IC card, NFC (Near Field Communication), a mobile terminal, or the like.

Location history recording unit 503 is a portion to record information in which consumers detected are associated with an installation location of place recording device 500, and is realized by software using a CPU and memory of the device.

Unlike location acquisition unit 501 and location history recording unit 503, classification ID reception unit 505 and classification ID issuance unit 506 are formed of an application or the like on a mobile terminal held by each consumer. In this case, place recording device 500 consists of an automatic ticket gate and a personal mobile terminal. Alternatively, when there is an additional server that manages personal information and use histories of magnetic cards or IC cards, classification ID reception unit 505 and classification ID issuance unit 506 may be built on this server. In this case, by each consumer presenting a magnetic card or an IC card at a purchase in a store, a classification ID assigned to the person is issued from classification ID issuance unit 506 on the server, and is acquired by classification ID acquisition unit 301 of first tabulation device 300.

Second tabulation device 600 has functions similar to functions of second tabulation device 400 shown in FIG. 1. A difference between second tabulation device 400 in FIG. 1 and second tabulation device 600 in FIG. 14 is a difference in history information between a content consumption history and a moved location history.

Location history acquisition unit 601 receives location histories of place recording devices 500 from location history recording units 503. Communication of the location histories is easily realized by server-client system communication, and thus location history acquisition unit 601 includes a communication means through an Internet connection such as a wired LAN or wireless Wi-Fi.

Location history storage unit 602 records and stores location history information on place recording devices 500 acquired by location history acquisition unit 601. Accordingly, location history storage unit 602 includes a recording device such as an HDD.

Based on the stored location histories of place recording devices 500, classification ID generation unit 603 divides a set of consumers into some groups with similar location history distributions, and generates classification IDs to identify the groups. At the same time, classification ID generation unit 603 determines typical rates of the location histories associated with each classification ID. For the grouping calculation and classification ID generation, classification ID generation unit 603 uses a device for reading data stored in an HDD as a database and a CPU.

In location frequency storage unit 604, a table indicating under which classification IDs place recording devices 500 fall, and a table representing a location history of each classification ID are stored. It is desirable for storage of these tables to use a recording device such as an HDD to store the tables as a database.

Other components of second tabulation device 600 are identical to the components denoted by the same reference numerals shown in FIG. 1, and will not be described.

### [2-2. Operation]

In the second exemplary embodiment, a content consumption history in the first exemplary embodiment is replaced with a location history, and other operations are the same. Here, a location history is a record of passing through or staying at a station or a passage of public transportation, a hotel, a department store, or the like. Hereinafter, a location history of public transportation, and sales of each product in a retail store as in the first exemplary embodiment will be described as an example.

### (Collection of Location Histories)

A consumer pays a fare before or after boarding by passing through an automatic ticket gate using a magnetic card, an IC card, or the like. The automatic ticket gate has location acquisition unit 501 provided with a user authentication function for confirming payment. By a consumer passing through the ticket gate, a consumer ID for identification of the consumer is associated with location information on a place where the automatic ticket gate is installed, in location history recording unit 503, and transmitted to second tabulation device 600 connected via a network. Second tabulation device 600 receives the location information by location history acquisition unit 601, and stores the location information in location history storage unit 602.

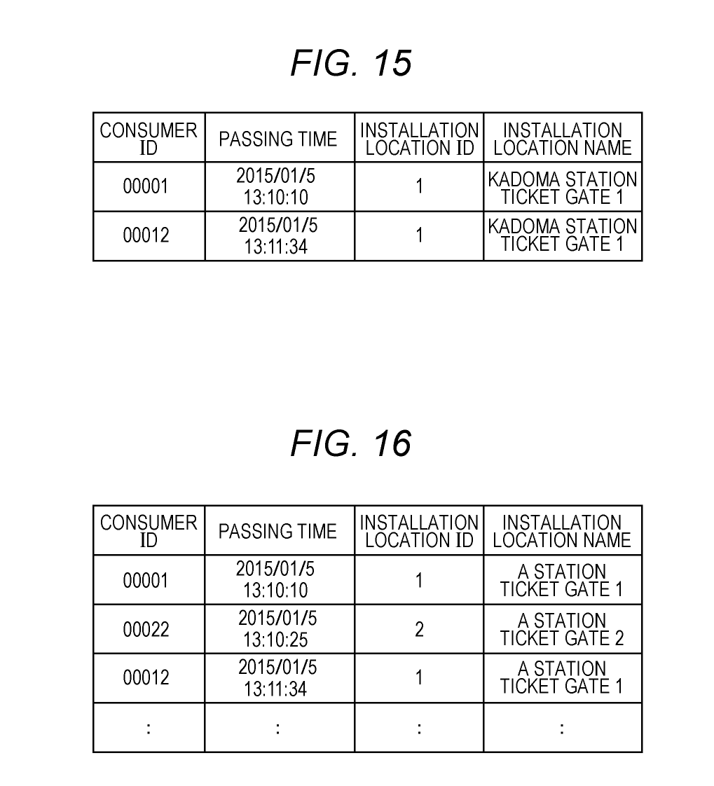

Examples of information recorded in location history recording unit 503 and information stored in location history storage unit 602 are shown in FIGS. 15 and 16. FIG. 15 is a location history generated and recorded by place recording device 500, an automatic ticket gate, every time a consumer passes through, in which location history consumer IDs of consumers who passed, passing time, and location information are recorded. An installation location ID and an installation location name as location information are of place recording device 500 recording this information. Second tabulation device 600 receives this information by location history acquisition unit 601, and stores the information in location history storage unit 602 as in FIG. 16. Location history storage unit 602 includes various installation location IDs and installation location names since information from place recording devices 500 installed in various places is collected.

A method of recording a location history at an automatic ticket gate to detect a location with magnetic cards or IC cards has been described. However, this is not limiting, and a similar operation may also be performed by a consumer carrying a mobile terminal such as a smartphone or tablet that can detect a location, and transmitting a detected location. In this case, location acquisition unit 501 and location history recording unit 503 are built in the mobile terminal.

### (Generation of Classification IDs)

Generation and recording of classification IDs are operations by classification ID generation unit 603 and location frequency storage unit 604. These are the same as operations of classification ID generation unit 403 and consumption frequency storage unit 404 in the first exemplary embodiment except that consumption frequency is replaced with location frequency. Specifically, from the location history information illustrated in FIG. 16, a number of times of passing through what installation ID location is counted for each consumer ID. The results are similar to the results in FIG. 4 in the first exemplary embodiment. An operation after creating a table of consumer IDs versus installation location IDs like this is the same as the operation in the first exemplary embodiment and will not be described.

### (Transmission and Reception of Classification IDs)

When classification IDs of consumers are stored in location frequency storage unit 604, a classification ID is extracted by classification ID determination unit 405 for each consumer, and is transmitted from classification ID transmission unit 406 to place recording device 500. The classification ID transmitted is received by classification ID reception unit 505 of place recording device 500. The classification ID is shaped into a usable form by classification ID issuance unit 506, together with other information such as advertisement information transmitted from second tabulation device 600.

Classification ID reception unit 505 and classification ID issuance unit 506 like these are desirably built on a mobile terminal such as a smartphone carried by a person. Therefore, when public transportation is used through an automatic ticket gate using a magnetic card or an IC card, it is required to associate personal information on the magnetic card or IC card with a mobile terminal owned. The association can be realized by registering ID information on the magnetic card or IC card on an application of the mobile terminal, or registering a telephone number of the mobile terminal when the magnetic card or IC card is purchased.

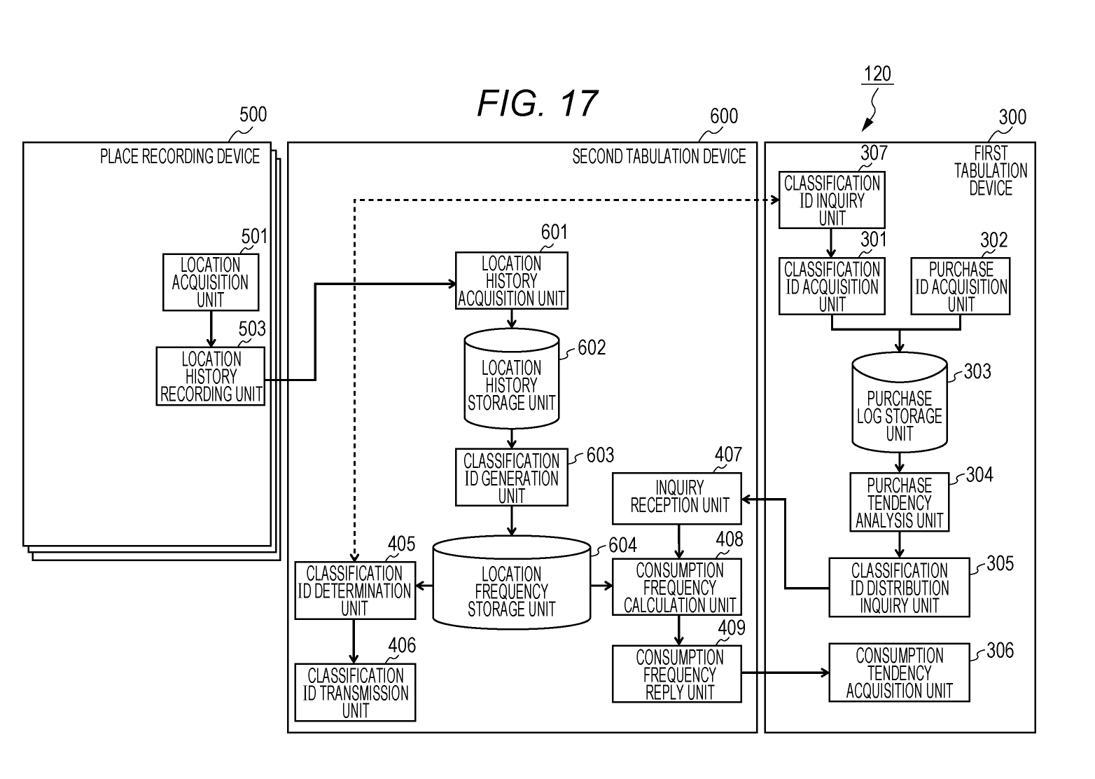

In another realization means, at the time of purchase in a retail store or the like, the classification ID can be communicated to the store through the magnetic card, IC card, or the like. In this case, a device for reading magnetic cards or IC cards is installed in the store, and by inquiring of second tabulation device 600 about a personal ID acquired from a magnetic card or an IC card, a classification ID of a consumer is acquired. FIG. 17 shows a configuration diagram showing this realization method. Here, data tabulation system 120 does not include classification ID reception unit 505 and classification ID issuance unit 506, compared to FIG. 14, but classification ID inquiry unit 307 is added. Classification ID inquiry unit 307 is a portion that inquires about and acquires classification IDs of consumers through personal IDs of magnetic cards or IC cards presented by the consumers.

(Product Purchase with Classification ID Presented)

In a case where classification IDs are issued on mobile terminals carried by persons, the same method as the method described in the first exemplary embodiment is used, and will not be described. When a magnetic card or an IC card, which is used at place recording device 500, an automatic ticket gate, is presented to perform a purchase in a store, a configuration in FIG. 17 allows a cross analysis of a location history and a product/service purchase history.

For an operation after consumers' location histories and product/service purchase histories are associated with each other and recorded, the same operation as the operation in the first exemplary embodiment allows a store to know what place consumers belonging to classification IDs who purchased a product or a product group in the store go frequently. Thus, the store can know in what place to place an advertisement for higher advertising effectiveness. Performing this processing does not allow a store to know location histories of individual consumers at all, and thus the consumers' privacy is not invaded.

### [1-3. Effects and Others]

As above, the tabulation system according to the second exemplary embodiment allows a cross analysis of information on what places consumers go frequently and information on what products/services they purchased while concealing both of them from each other. Therefore, a store can know a place that provides high product/service advertising effectiveness without invading consumers' privacy in behavior.

The above-described exemplary embodiments are intended to illustrate a technique in the present disclosure, and thus various kinds of change, replacement, addition, omission, and the like can be performed within the scope of the claims or the scope of the equivalence.

The present disclosure is applicable to a tabulation device that performs a cross analysis, using records of content viewing and product purchase held by different business entities. Specifically, the present disclosure is applicable to a cross analysis of a consumption history in a television, a radio, an electronic book, or the like and a history of purchasing a product/service in a real store, or a cross analysis of a location history of moving to/staying at public transportation, a hotel/square, or the like, and a history of purchasing a product/service.

What is claimed is:

1. A tabulation system comprising:
a first tabulation device including:
a classification ID acquisition unit that acquires classification IDs of consumers;
a purchase ID acquisition unit that acquires purchase IDs of products or services; and
an analysis unit that tabulates the classification IDs and the purchase IDs, and analyzes first tabulation information indicating distribution of the classification IDs with respect to the purchase IDs; and
a second tabulation device including:
a classification ID generation unit that generates the classification IDs, based on frequency of a predetermined behavior of the consumers; and
a calculation unit that calculates second tabulation information indicating distribution of the frequency of the predetermined behavior with respect to distribution of the purchase IDs, based on the first tabulation information input from the first tabulation device and the classification IDs,
wherein the first tabulation device acquires the second tabulation information.

2. The tabulation system according to claim 1, wherein the calculation unit generates the second tabulation information by determining an inner product of the frequency of the predetermined behavior represented by the classification IDs and a component ratio of the classification IDs with respect to each of the purchase IDs, based on the first tabulation information.

3. The tabulation system according to claim 2, wherein the predetermined behavior is a viewing of content or a combination of viewings of a plurality of content pieces.

4. The tabulation system according to claim 2, wherein the predetermined behavior is a visit to a predetermined place or a combination of visits to a plurality of predetermined places.
